(19) United States
(12) Patent Application Publication
(10) Pub. No.: US 2026/0049593 A1
(43) Pub. Date: Feb. 19, 2026

(54) LARGE ROLLER BEARING AS BLADE, AZIMUTH OR MAIN BEARINGS FOR WIND TURBINES

(71) Applicant: IMO Holding GmbH, Gremsdorf (DE)

(72) Inventor: Werner SCHROEPPEL, Wendelstein (DE)

(21) Appl. No.: 19/298,944

(22) Filed: Aug. 13, 2025

(30) Foreign Application Priority Data
Aug. 14, 2024 (DE) 10 2024 123 253.6

(51) Int. Cl. F03D 1/06; F03D 80/70

(52) U.S. Cl. CPC F03D 1/066; F03D 1/0675; F03D 80/70; F05B 2260/79

(57) ABSTRACT

A large roller bearing has an inner ring and an outer ring, raceways for rolling elements received between these raceways, a first and a second end face. First fastening means extend from the first to the second end face, wherein each of the first fastening means is aligned with a bore of a first connecting element. An adapter ring extends from the outer or inner ring axially toward the first or a second connecting element. The adapter ring has a first and a second end face, and second fastening means extend from its first to its second end face, and each second fastening means is aligned with a bore of a second connecting element. Third bores are spaced apart from one another, wherein each of the third bores is aligned at the first end face of the adapter ring with a bore of the outer ring or the inner ring.

### CROSS-REFERENCE TO RELATED APPLICATION

This application claims the benefit of priority to German Patent Application No. 10 2024 123 253.6, filed on 14 Aug. 2024.

### TECHNICAL FIELD AND INTRODUCTION

This invention relates to a large roller bearing (diameter 2 m to over 10 m) as a blade, azimuth or main bearing for a wind turbine. Furthermore, an adapter ring for extending a large roller bearing in the axial direction toward a first connection element or a second connection element is disclosed. Furthermore, a wind turbine is disclosed in which at least one such large roller bearing with such an adapter ring is arranged. Features are defined in the patent claims below; however, the description and the figures also disclose relevant details.

### BACKGROUND AND STATE OF THE ART

Under the name “T-Solid,” such large roller bearings from IMO GmbH &amp; Co. KG, 91350 Gremsdorf, Germany, are available on the market, in particular for rotor blades of a wind turbine, which have at least two axially offset raceways with circumferential rolling elements. In T-Solid large roller bearings, axial load components are supported by axial raceways and radial loads by radial raceways. T-Solid large roller bearings are a three-ring design with a T-shaped, one-piece ring mounted on the rotor blade side and a two-piece ring mounted on the hub side. T-Solid large roller bearings are also used in a reverse configuration, in which the single-piece ring is mounted on the rotor blade side and the two-piece ring is mounted on the hub side.

The bearing arrangement has two ring-shaped elements that can rotate relative to each other for direct or indirect connection to the rotor blade hub on the one hand and to a rotor blade on the other. Rolling elements between axially offset raceways have an approximately cylindrical shape, i.e., each with a surface that is rotationally symmetrical about exactly one axis of rotation. To absorb the tilting moment (root bending moments) caused by the wind pressure on the rotor blade and acting on the bearing arrangement, as well as the thrust and transverse forces (and, if necessary, to absorb other forces such as gravitational forces caused by the blade mass, centrifugal forces due to rotation, inertial forces due to acceleration or deceleration, etc., and/or other forces and moments), two raceways (not in single-row blade bearings) are arranged between the two connecting elements, offset axially from each other, with circumferential rolling elements of approximately cylindrical or spherical shape. The rolling elements are (in blade bearings with rollers) aligned approximately perpendicular to the longitudinal axis of the rotor blade in question.

Due to the limited installation space between the rotor hub and the rotor blade, and in particular due to the installation space restricted radially by their mounting holes, blade bearings are increasingly subject to overload and can therefore develop operational or structural strength problems and fail prematurely. With, for example, “Type Vestas V27 to V29 Rotor Blade Extenders” between the blade bearing and the rotor blade, an attempt is made to stiffen the foot of the rotor blade and to screw the rotor blade made of fiber composite material (e.g., glass or carbon fiber reinforced plastic) to the blade bearing more easily and with increased structural strength. This also increases the rotor diameter through simple, cost-effective designs that do not require aerodynamic shaping, as they have little aerodynamic effect in this area. These Type Vestas V27 to V29 Rotor Blade Extenders are approx. 2 m long GRP tubes with a flange at each end. These flanges each have a single row of holes for fastening the rotor blade extender between the blade bearing and the rotor blade. The hole circles at both ends of the Vestas V27 to V29 rotor blade extender have the same hole circle diameter. Blade extenders in steel construction are also known from operational practice.

DE 10 2007 008 167 A1 shows a wind turbine with a rotor hub equipped with a pitch rotation connection. A rotor blade has a flange at the blade root for connection to the pitch rotation connection. A stiffening element between the flange at the blade root and the pitch rotation connection increases the radial stiffness in the area of the blade root in particular. The stiffening element is held in place by the connecting means between the pitch rotation connection and the rotor blade root, which are also used when the rotor blade is attached directly to the pitch rotation connection.

Due to the increasing prevalence of wind turbines in recent years (decades), a large number of blade bearings are in use, for example, which have developed problems with operational stability (fatigue problems, such as vibration-induced crack corrosion/blade bearing cracks and/or cracks due to mounting holes, auxiliary holes, and ball/roller filling openings) or have overloaded raceways that fail earlier than expected due to frequent rollover by the rolling elements or edge running (ellipse truncation) or as a result of cage failure.

Due to unpredictable high loads (e.g., wind) on these bearings in exposed locations with turbulent winds or changes to the system (higher hub heights, longer rotor blades, or use of systems for higher wind regimes/wind classes), failures are not uncommon after just a few years of operation. These failures result in costly measures in the form of replacement with brand new bearings using replacement screw sets, transport of these to the wind farm, installation costs, etc.

This also results in production downtime. The crane required to replace the bearing is large, expensive, and often difficult to obtain. If the original bearing type with the original specifications (quality, dimensions, material selection, design/construction, etc.) is used, the same problems may recur after a few years. This would require a repeated, equally costly replacement.

Therefore, there is a requirement to provide blade bearings with a significantly longer service life and load capacity as well as increased operational stability. Usually, the connection situation (diameter at the base of the rotor blade, diameter of the rotor hub, number, spacing, and dimensions of the fastening collars and fastening means, etc.) for the bearing on the rotor hub on the one hand and the rotor blade on the other, or on the tower and the tower house, is strictly specified and severely restricts the selection and dimensioning of the blade bearing or the azimuth or tower house bearing with the improved properties described. For example, the inner ring of the bearing must be connected to the rotor blade and the outer ring of the bearing to the rotor hub (or vice versa).

This means that the connection situation is independent of the specific design of the bearings (single-row, double-row, triple-row or even multi-row ball, tapered, barrel or roller slewing bearings, double-row tapered roller bearings, cross roller bearings, double axial bearings, combined axial and radial bearings or similar as four-point bearings, axial bearings, radial bearings, deep groove ball bearings or combinations thereof and any other design used as leaf, azimuth or main bearings).

Connection situations without the solution presented here can be found, for example, in “Wind Turbine Design Guideline DG03: Yaw and Pitch Rolling Bearing Life” Matthias Stammler, Oliver Menck, Yi Guo, and Jon Keller Technical Report NREL/TP-5000-89161 July 2024 of the National Renewable Energy Laboratory, Golden, Colorado, USA (www.nrel.gov).

An example of such a connection situation is also shown in DE 10 2005 026 141 A1. This connection situation is explained below with reference to FIG. 4. A blade bearing 1 of a wind turbine serves here to connect a rotor blade 2 to a rotor hub 3 in a rotatable manner. The rotor blade 2 is made of fiber composite material in the manner of a wing. The rotor blade 2 has a shell surface 4 surrounding a cavity, which merges at its rotor hub-side end 5 into a circular cylinder with a diameter of several meters, which has a flat connection surface 6 with a circular ring shape. A series of blind holes 7 with anchoring bodies 8 protrude into this connecting surface 6 in a ring shape, which have an internal thread here. The rotor hub 3 has a bulge 9 for each rotor blade 2, each with a flat circular connecting surface 10. The connecting surface 10 encloses a circular opening 11. Blind holes 12 arranged in a ring also protrude into these connecting surfaces 10, which have an internal thread here.

The blade bearing 1 is arranged between the two connecting surfaces 6, 10 with two ring-shaped inner and outer rings 13, 14 that are concentric to each other and can be rotated relative to each other. These inner and outer rings 13, 14 usually have induction-hardened running surfaces for rolling elements of two axial bearings and a radial bearing. In the variant shown, the inner ring 13 is divided into two part rings with running surfaces arranged one above the other. Each of the two end faces 15, 16 of these inner and outer rings 13, 14 facing away from each other lies fully against a connecting surface 6, 10 of the rotor blade 2 or the rotor hub 3. To connect the inner and outer rings 13, 14 to the rotor blade 2 on the one hand and the rotor hub 3 on the other, a series of through-bores 17, 18 are provided in the inner and outer rings 13, 14 for corresponding stud bolts or screws.

The through-bores 17 of the inner ring 13 correspond in number, diameter, and alignment to the blind holes 7 in the connecting surface 6 of the rotor blade 2 in such a way such that each through hole 17 of the inner ring 13 is aligned with a blind hole 7 in the connecting surface 6 of the rotor blade 2, allowing a stud bolt or screw 19 to be inserted and tightened. Similarly, the through holes 18 of the outer ring 14 correspond in number, diameter, and alignment to the blind holes 12 in the connecting surface 10 of the rotor hub 3 in such a way that that each through hole 18 of the outer ring 14 is aligned with a blind hole 12 in the connecting surface 10 of the rotor hub 3, allowing a stud bolt or screw 20 to be inserted and tightened.

### SUMMARY

### Underlying Problem

On the one hand, there is a requirement for existing wind turbines—with a specified rotor hub and rotor blade root—to provide a bearing arrangement with higher load-bearing capacity, rigidity, capacity, and/or service life than before, usually with higher operational stability at the same time. On the other hand, there is a requirement for a new wind turbine, where the dimensions of the cast resin mold forming the rotor blade and the cast steel mold forming the rotor hub are specified or are to be retained, to provide a bearing arrangement with higher load-bearing capacity, stiffness, capacity, and/or service life, usually with higher operational stability than these dimensions have allowed to date. This should enable the cost-effective and rapid implementation of wind turbines for higher demands and loads, with a high proportion of identical parts for the complex and expensive components, as in wind turbines that have already been planned or introduced.

### Solution

In the blade bearing of FIG. 4 discussed above (analogous to all other conceivable blade bearing designs), the radial distance between the fastenings 17 of the inner ring 13 and the fastenings 18 of the outer ring 14 determines the space available for the axial bearing raceway system with its rolling elements and, if applicable, for the radial bearing.

In order to be able to achieve a bearing arrangement with higher load carrying capacity, rigidity, capacity and/or service life as well as increased operational stability in this connection and installation situation despite this restriction, a large roller bearing with the features of patent claim 1 is proposed.

This large roller bearing has an inner ring and an outer ring arranged concentrically therewith. The inner ring and the outer ring have respective raceways for rolling elements received between these raceways. The inner ring and the outer ring each have a first and a second end face. The inner ring or the outer ring has a plurality of first fastening means.

These first fastening means are arranged along the circumference of the inner ring or the outer ring at a distance from each other and form a first fastening collar. These first fastening means are each provided and designed to align with a corresponding fastening element of a first connection element or a second connection element.

An adapter ring is designed to extend the outer ring or the inner ring in the axial direction toward the first connecting element or a second connecting element. The adapter ring has a first and a second end face. The adapter ring has a plurality of second fastening means extending from its first end face to its second end face. These second fastening means are arranged at intervals along the circumference of the adapter ring and form a second fastening collar. The second fastening means are provided and designed to be aligned with a corresponding fastening element of a second connecting element. A plurality of third fastening means provided on the first end face of the adapter ring are arranged at intervals along the circumference of the adapter ring and form a third fastening collar. Each of the third fastening means is aligned on the first end face of the adapter ring with a corresponding fastening of the outer ring or the inner ring. The diameter of the third fastening collar is greater than the diameter of the second fastening collar.

In some variants, the first, second, and third fastening means—also referred to as first, second, and third fastenings—of the bearing rings or the adapter ring are designed as (through) bores. Screw bolts are inserted into these (through) bores and screwed together with nuts. Instead of the (through) bores, variants with (internal thread) bores are also provided, for example, into which screw bolts are screwed. Alternatively, in some variants, stud bolts are provided which are fastened at one end, for example by a threaded connection in a blind hole, or are inserted and held in place with a nut.

An additional or alternative explanation of the solution presented here, relating to the diameters of the third and second mounting collars, refers to the diameter of the raceway of the most heavily loaded rolling elements (in this case, the axially loaded balls or rollers of the large roller bearing or the axially and radially loaded balls in four-point bearings). The rolling circle diameter is the diameter of the rolling elements on the raceway, measured between the centers of diametrically opposed rolling elements. In one variant, the rolling circle diameter is understood as the mean diameter of the annular raceway of the rolling elements.

In one variant of the large roller bearing, the adapter ring is connected to the second connecting element (for example, the rotor hub). The rolling circle diameter of the large roller bearing is closer to the mounting collar of the adapter ring fastenings to the second connecting element than to the mounting collar of the inner or outer ring fastenings to the first connecting element (for example, the rotor blade), or the pitch diameter exceeds the diameter of the mounting collar of the fastenings on the adapter ring to the second connecting element.

In a variant of the large roller bearing, the adapter ring is connected to the first connection element and the rolling circle diameter is closer to the mounting collar of the adapter ring's fastenings to the first connection element than to the mounting collar of the inner or outer ring to the second connection element. In a variant of the large roller bearing, the rolling circle diameter exceeds the diameter of the fastening collar of the fastenings on the adapter ring to the first connecting element.

In the solution disclosed here, the raceway diameter of the large roller bearing is closer to the fastening collar of the fastenings of the adapter ring to the rotor hub or to the blade root than to the fastening collar of the fastenings of the bearing inner ring to the blade root or to the rotor hub (depending on whether the adapter ring is connected to the blade root or to the rotor hub).

In a variant of the solution disclosed here, in which the adapter ring is connected to the blade root, the running circle diameter is closer to the mounting collar of the adapter ring fastenings to the rotor blade than to the mounting collar of the bearing ring to the rotor hub. In some variants, the pitch circle diameter may also exceed the diameter of the fastening flange of the fastenings on the adapter ring toward the hub.

This arrangement allows the connection situation for fastening the blade bearing to the first connection element (e.g., foot of the rotor blade) and the second first connection element (e.g., rotor hub) to remain unchanged. In addition, the (screw) connection between either the inner ring or the outer ring at its respective first connection element or second connection element remains unchanged. However, the adapter ring also allows the (screw) connection between the respective other ring (outer ring or inner ring) at its respective other connection element (second or first connection element) to remain unchanged. Nevertheless, a radially larger installation space is provided between the first and second mounting collar to accommodate a blade bearing with the improved properties described.

To achieve this radially larger installation space or clearance between these two mounting collars, the other ring (outer ring or inner ring) of the large roller bearing is extended with the adapter ring, preferably in the axial direction relative to the hub (or blade). The radial extension also increases. The arrangement in which the outer ring of the bearing is extended with the adapter ring is explained below. This adapter ring has a (second) mounting collar that is aligned with the mounting collar of the first or second connecting element and a further, third mounting collar that is aligned with the mounting collar of the outer ring of the large roller bearing. This third mounting collar of the outer ring is positioned further out radially than the mounting collar of the corresponding first or second connecting element. This provides for the radial distance and thus the free space available for the bearing arrangement (raceways, rolling elements, etc.), in particular in the radial direction between the fastening collar of the inner ring and the fastening collar of the outer ring, being increased independently of the fastening collars of the first and second connecting elements (e.g., foot of the rotor blade and rotor hub) in the radial direction (outward or inward). This means that, with identical connection situations for the first and second connection elements, a large roller bearing with a larger radial dimension can be realized independently of the specific design of the bearing arrangement, which in turn offers higher load carrying capacity, rigidity, capacity, and/or service life as well as increased operational stability.

The approach presented here proposes an adapter ring that supplements the large roller bearing and, given a specified connection situation (diameter of the mounting collars, etc.) on the rotor hub and at the base of the rotor blade, allows a bearing arrangement that is not restricted by this to be accommodated.

The interfaces of the large roller bearing with the rotor blade (mounting collar, number and size of screws), the rotor hub (mounting collar, number and size of screws) and, if applicable, the drive pinion for blade adjustment in the case of electric blade adjustment (design of the gearing and its position) can be retained. This avoids unnecessary additional conversion costs. The greater axial extension is generally not a problem, as the structure preferably only extends slightly radially outwards (or, if necessary, inwards) and axially in the direction of the rotor blade, i.e., it does not interfere with any components inside the bearing arrangement. The increase in weight of the large roller bearing is generally not an obstacle, given the tolerances and size of the rotor blades and the associated dispersion.

The presented solution enables a significantly improved bearing arrangement, size, and design, in which the raceway sections that carry the axial and radial loads can be significantly enlarged and larger rolling elements and/or other rolling element shapes (e.g., rollers instead of balls or mixed configurations) and bearing designs are possible. Two- or three-row (multi-row) raceway systems can also be accommodated here, for example, where previously only single- or double-row four-point bearings were used. The weakest cross-section of the bearing between the screw mounting holes and the raceway of the rolling elements can also be significantly enlarged, as otherwise ring cracks can form in this weakened area due to gravitational or wind forces, which can lead to catastrophic failure of the blade bearing and/or its connecting structure, as has already been observed in the field.

In the event of a repair, the original bearing arrangement can have any possible design: a single-row or multi-row four-point bearing, a three-row roller bearing, an IMO T-Solid, a cross roller bearing, a double axial bearing (ball/ball) or any other design. The same applies to the new, enlarged blade bearing to be installed with higher load capacity, longer service life, and lower ring stresses to prevent fatigue damage (ring cracks). The inner and outer rings of blade bearings with different ring or raceway geometries can also be arranged in reverse, e.g., the T-shaped nose ring as the inner ring and the C-shaped split ring as the outer ring, or vice versa. The same applies to the placement of the adapter ring. It can be used on both the rotor blade side and the rotor hub side.

The following arrangements are therefore possible:
1. Rotor hub—adapter ring—rolling bearing—rotor blade
2. Rotor hub—roller bearing—adapter ring—rotor blade

These arrangements are to be implemented independently of other possible designs, e.g., stiffening rings or plates or other components, such as rings or plates for articulation in hydraulic blade adjustment, which are fastened in between.

Variants are provided in which either (a) the inner ring or (b) the outer ring of the rolling bearing is fastened to the rotor hub. In this case, the rotor blade is connected via the adapter ring to (a) the outer ring of the rolling bearing or (b) the inner ring.

In the reverse arrangement, either (a) the inner ring or (b) the outer ring of the rolling bearing is attached to the rotor blade. In this case, the rotor hub is connected via the adapter ring to (a) the outer ring of the rolling bearing or (b) the inner ring.

It is also possible to make the bearing arrangement larger radially inwards or larger radially outwards. In the first case, the adapter ring extends the inner ring, in the second case, the adapter ring extends the outer ring.

In the event of a repair, the connection situation is fixed. To enable future-proof repair, the undersized blade bearing (which often only becomes apparent after years of use) must be replaced, but there is no space for a larger bearing (with more or larger rolling elements, additional rows of rolling elements, different rolling elements, e.g., rollers instead of balls). The adapter ring presented here allows a new, reinforced raceway system (more or wider raceways, larger rolling elements, multi-row arrangements) that no longer has to fit between the two unchangeable mounting rings of the rotor hub and the rotor blade, so that a larger installation cross-section is available for the raceway system (and the rolling elements).

In the event of a redesign of the wind turbine, it is possible to continue using existing blade GRP molds and hub cast steel molds for turbines that are subject to higher loads due to more demanding locations and/or wind conditions. The adapter ring presented here allows existing wind turbine designs, including their existing blades/molds and hubs/molds, to be upgraded for higher loads by using bearings with higher load-bearing capacity/service life. This makes existing key components (rotor blades, rotor hub, other components) quickly and cost-effectively available for further, more demanding applications (modular design).

The adapter ring makes it possible to use a more resilient blade bearing and/or a blade bearing with higher operational stability without any other modifications. This is a minor expense compared to extremely costly modifications to the hub body or the rotor blades. (This applies in particular to cases where the blade bearing was the weak point).

In one variant of the large roller bearing, the inner ring can be designed as a single or multi-part component. Similarly, in one variant of the large roller bearing, the outer ring can be designed as a single or multi-part component. This serves to accommodate additional rows of rolling elements and to simplify the installation of the rolling elements in the bearing arrangement.

In a variant of the large roller bearing, the adapter ring can be designed without a raceway. In a variant of the large roller bearing, the adapter ring can also carry a raceway if geometrically possible.

This allows the adapter ring to be made of a less demanding steel than the raceway-bearing inner ring and the outer ring of the large roller bearing, or of a steel that is more suitable for gear teeth.

In a variant of the large roller bearing, the second fastenings of the second fastening collar can be arranged along the circumference of the adapter ring offset to the third fastenings of the third fastening collar along the circumference of the adapter ring. This optimizes the stability of the adapter ring while limiting the necessary diameter of the outer ring of the bearing. Depending on the diameters of the fastenings of the second and third fastening collars, these fastenings may overlap in the circumferential direction of the adapter ring.

In another variant, the second fastenings of the second fastening collar can also be arranged in alignment with the third bores of the third fastening collar in the radial direction or partially overlapping in the radial direction.

In a variant of the large roller bearing, at least the second fastenings of the second fastening collar can have stepped bores. This allows fastening screws, e.g., hexagon socket screws or similar designs, to be completely accommodated. This allows the adapter ring to be fastened to the first or second connecting element without the fastening screws protruding beyond the end face of the adapter ring.

In a variant of the large roller bearing, the third fastenings of the third fastening collar can be designed as blind holes and have an internal thread so that they are closed even if the adapter ring protrudes radially beyond the rotor hub bearing surface.

In a variant of the large roller bearing, electrical adjustment of the rotor blade can be provided by means of a controlled electric motor with an intermediate gear, which carries a drive pinion on its output shaft. In a variant of the large roller bearing, the drive pinion meshes with internal teeth arranged on the inner ring or outer ring or with external teeth. In a variant of the large roller bearing, hydraulic adjustment is provided by means of a controlled hydraulic cylinder which is articulated on the inner ring or outer ring. This allows controlled adjustment/rotation of the rotor blade about its longitudinal axis. In the case of hydraulic adjustment of the rotor blade, support plates are usually located between the blade bearing and the rotor blade and/or between the blade bearing and the hub to accommodate the hydraulic adjustment device. Care must be taken to ensure that these support plates (and, if applicable, the hydraulic adjustment device) do not interfere with a bearing arrangement that extends radially inwards. In the simplest case, a radially outwardly extended overall arrangement is suitable.

In a variant of the large roller bearing, the area supporting the internal/external gearing may be made of a different material than the area supporting the raceways of the large roller bearing of the inner ring and/or the outer ring. This area would then preferably be connected to the area of the bearing supporting the raceways by fastening means. In a variant of the large roller bearing, the adapter ring can be made of a different material than a raceway-bearing area of the large roller bearing or the area of the bearing that carries the gearing. In this case, less expensive steels or steels that are more suitable for gearing can be used for both the area with the internal gearing or external gearing and for the adapter ring. In further variants, the gearing area can be omitted to reduce weight or specially designed to adapt the support plates for the adjustment device. No gearing is required for hydraulic blade adjustment.

In a variant of the large roller bearing, a radially projecting, circumferential nose ring with an approximately rectangular cross-section can be provided on the inside of the outer ring or on the outside of the inner ring. The journal ring has circular (upper and lower) side surfaces in cross-section. These side surfaces form raceways for the rolling elements (axially effective) rolling on them.

In a variant of the large roller bearing, the (axially effective) rolling elements can be designed as balls, rollers, barrel rollers, or tapered rollers. In the case of rollers, in one variant of the large roller bearing, the rolling elements are oriented such that the longitudinal axes of the axially supporting rolling elements are approximately perpendicular to the longitudinal axis of the rotor blade and the radially supporting rolling elements are approximately parallel to the longitudinal axis of the rotor blade. In a variant of the large roller bearing, the radial extension of the nose ring may correspond approximately to the diameter/length of a rolling element, the raceways being slightly wider than the rollers are long, provided that a cage is used for the rolling elements. In a variant of the large roller bearing, the nose ring has a (vertical) circumferential surface that forms a raceway for a radial bearing, which is preferably designed as the manner of a roller bearing or a ball bearing, wherein this raceway may be recessed in the nose.

In a variant of the large roller bearing, a circumferential recess of approximately rectangular cross-section is provided on the outside of the inner ring or on the inside of the outer ring. This recess has a depth that corresponds approximately to the diameter/length of a rolling element.

In a variant of the large roller bearing, the recess has circular ring-shaped (upper and lower) side surfaces in cross-section. These side surfaces form raceways for the rolling elements they accommodate.

In a variant of the large roller bearing, the recess can be limited in the axial direction by a (upper and lower) ring collar projecting toward the other (inner or outer) ring. A ring-shaped sealing element can be arranged (top and bottom) between these ring bands of the bearing arrangement and the corresponding areas of the other (inner or outer) ring of the bearing arrangement—or of the adapter ring. In some variants, the seals are accommodated in recesses.

In variants, a first sealing element is accommodated in a ring groove near a first end face on the outer circumference of the inner ring and seals the bearing clearance of the bearing arrangement by rubbing against the outer ring. The first sealing element can also be accommodated in a ring groove on the inner circumference of the outer ring and seals the bearing clearance of the bearing arrangement by rubbing against the inner ring.

In addition, a second sealing element is accommodated in a ring groove near a second end face on the inner circumference of the outer ring and seals the bearing clearance of the bearing arrangement by rubbing against the inner ring. The second sealing element can also be accommodated in a ring groove on the outer circumference of the inner ring and seals the bearing clearance of the bearing arrangement by rubbing against the outer ring.

In addition, or alternatively, a sealing element is provided in variants which seals the bearing clearance by rubbing against the adapter ring.

In one variant of the large roller bearing, the rotor hub, adapter ring, inner ring, and outer ring can be radially centered relative to each other, depending on which ring carries the rotor blade. This can be achieved in one variant (continuously or only partially) by means of centering collars or centering pins and the like. This also applies to the reverse design: blade, adapter ring, inner ring/outer ring.

In a variant of the large roller bearing, the inner ring or the outer ring can be divided axially into two halves of approximately equal height, which are assembled and screwed together when the bearing arrangement is assembled after the rolling elements have been inserted. In a variant of the large roller bearing, one of the two halves also has a raceway of the radial bearing corresponding to the raceway of the opposite ring.

An adapter ring is designed and arranged to extend an outer ring or an inner ring of a large roller bearing in the axial direction toward a first connecting element (e.g., rotor blade) or a second connecting element (rotor hub). The adapter ring has a first and a second end face. The adapter ring has a plurality of second fastenings extending from its first to its second end face. These second fastenings are arranged at intervals along the circumference and form a second fastening collar. Each of the second fastenings is designed and arranged to align with a corresponding fastening element of a second connecting element. A plurality of third fastenings provided on the first end face of the adapter ring are arranged at intervals along the circumference of the adapter ring and form a third fastening collar. Each of the third fastenings is aligned on the first end face of the adapter ring with a corresponding fastening of the outer ring or inner ring of the adapter ring. The diameter of the third fastening collar is greater than the diameter of the second fastening collar.

In one variant of the adapter ring, it is designed without a raceway. In one variant of the adapter ring, the second fastenings of the second fastening collar are arranged along the circumference of the adapter ring offset from the third bores of the third fastening collar.

In one variant of the adapter ring, at least the second fastenings of the second fastening collar are designed as stepped bores for completely receiving fastening screws for screwing the adapter ring to a first or second connecting element.

In a variant of the adapter ring, the third fastenings of the third fastening collar are formed as blind holes with internal threads.

A wind turbine is equipped with a tower, a tower house arranged on the tower so as to be rotatable in azimuth, and a generator arranged in the tower house, which has a rotor hub on which several rotor blades are arranged so as to be rotatable about their longitudinal axis. At least one large roller bearing as described above with an adapter ring as described above is arranged between the tower and the tower house, and/or between the tower house and the rotor hub, and/or between the rotor hub and the rotor blades.

### BRIEF DESCRIPTION OF THE DRAWINGS

Further features, characteristics, advantages, and effects based on the invention are apparent from the following description of some preferred embodiments of the invention and from the drawing. Herein:

FIG. 1 shows a partial longitudinal section through a bearing arrangement of a rotor blade in the installed state between the rotor hub and the rotor blade along a vertical section plane;

FIG. 2 shows a partial longitudinal section through a bearing arrangement of a rotor blade in the installed state between the rotor hub and the rotor blade along a vertical section plane offset in the circumferential direction relative to FIG. 1;

FIG. 3 is a partial perspective sectional view of an adapter ring disclosed herein from FIGS. 1 and 2; and

FIG. 4 shows a partially enlarged section through a known bearing arrangement of a rotor blade in the installed state between the rotor hub and the rotor blade.

### DETAILED DESCRIPTION OF THE DRAWINGS

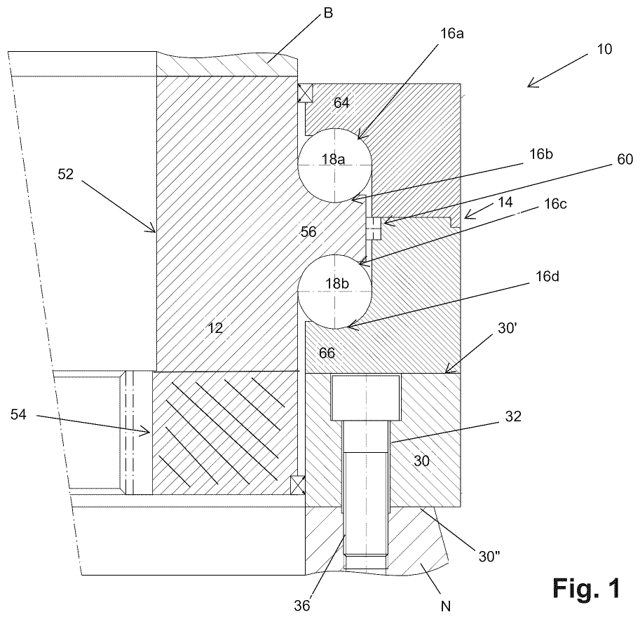

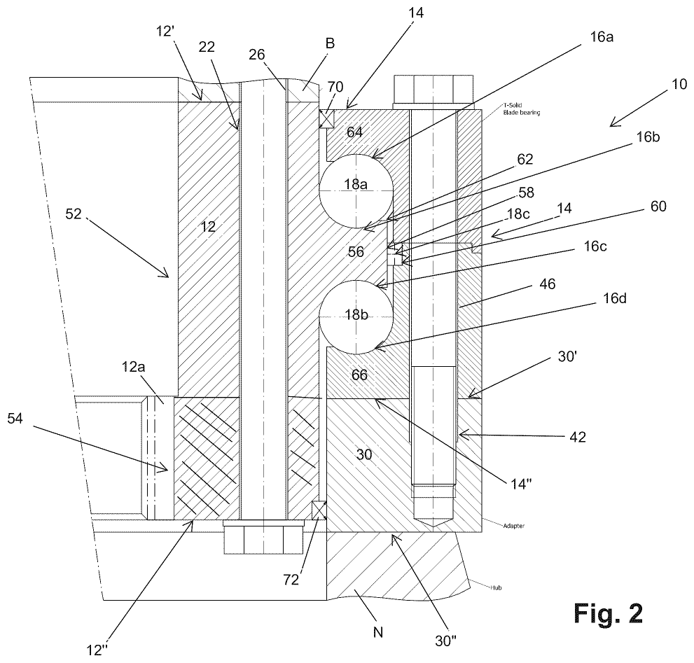

FIGS. 1 and 2 show a centerless bearing arrangement of a rotor blade in the installed state between a rotor hub N and a rotor blade B. The rotor hub N and the rotor blade B are only schematically indicated. This large roller bearing 10 has an inner ring 12 and an outer ring 14 arranged concentrically with the inner ring 12.

The inner ring 12 and the outer ring 14 are essentially circular cylindrical in design and separated by a bearing clearance. In the variant illustrated here, the inner ring 12 and the outer ring 14 carry two rows of rolling elements 18a, 18b on respective surface-treated raceways 16a . . . 16d. These rolling elements 18a, 18b are accommodated between these raceways 16a . . . 16d.

The inner ring 12 and the outer ring 14 each have (in FIGS. 1 and 2 above and below) a first and a second end face 12′, 14′; 12″, 14″. FIGS. 1 and 2 illustrate a variant in which the inner ring 12 has a plurality of first fastenings 22 extending between its end faces 12′, 12″. These fastenings are arranged at intervals in the circumferential direction of the inner ring 12 and form a first fastening collar 24 for fastening screws. Each of the first fastenings 22 is aligned with a respective bore 26 of the first connecting element, in this case the rotor blade B.

Here, the fastening means or fastenings 22 of the bearing rings 12, 14 or of the adapter ring 30 explained below are designed as (through) bores into which screw bolts are inserted and screwed with nuts. In addition to the (through) bores, fastening means or blind bores are also used. In variants not shown in detail, fasteners are provided in the form of (internal thread) holes into which screw bolts are screwed, or stud bolts which are fastened at one end, for example by a threaded connection in a blind hole, or screw bolts are inserted and tightened with a nut.

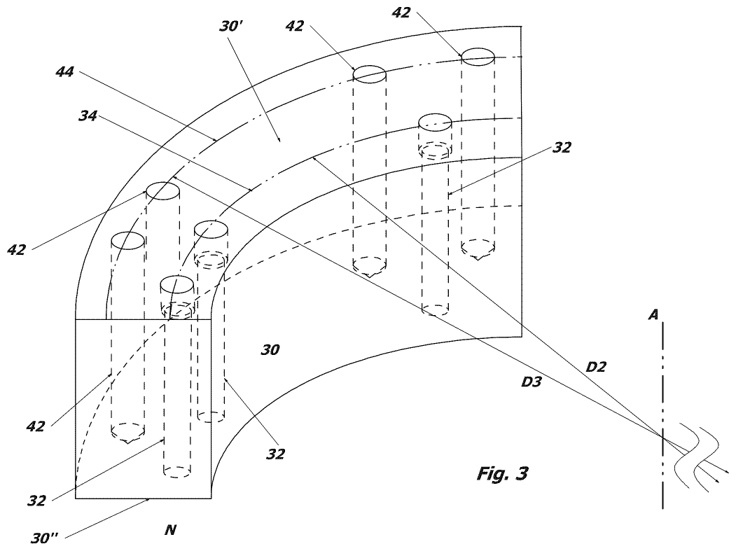

In the variant illustrated in FIGS. 1, 2, and 3, an adapter ring 30 is provided which extends the outer ring 14 in the axial direction toward the second connection element, here the rotor hub N. The adapter ring 30 has a first and a second end face 30′, 30″ (at the top and bottom in FIGS. 1 and 2) and a plurality of second fastenings 32 extending between its end faces 30′, 30″. These second fasteners 32 are arranged at a distance from one another in the circumferential direction of the adapter ring 30 and form a second fastening collar 34. Each of the second fasteners 32 is aligned with a respective fastening element in the form of a bore 36 of the second connecting element, here the rotor hub N.

The adapter ring 30 in the variant illustrated in FIGS. 1, 2, and 3 has a plurality of third fastenings 42 in the form of third bores 42 on its first end face 30′. These bores 42 are arranged at a distance from one another in the circumferential direction of the adapter ring 30 and form a third fastening collar 44. In the variant shown in FIGS. 1 and 2, each of the third holes 42 is aligned on the first end face 30′ of the adapter ring 30 with a respective through fastening of the outer ring 14 in the form of a hole 46.

In the variant of the adapter ring 30 illustrated in FIGS. 1, 2, and 3, the second fastening collar 34 has a diameter D2 and the third fastening collar 44 has a diameter D3. The diameter D3 of the third fastening collar 44 is larger than the diameter D2 of the second fastening collar 34.

In the variant shown in FIGS. 1 and 2, the inner ring 12 is designed as a single piece in the axial direction. In the variant shown in FIGS. 1, 2, and 3, the outer ring 14 is designed as two pieces in the axial direction.

The adapter ring 30 is designed without a raceway and can therefore be made of lower-quality steel than the inner and outer rings.

In the variant of the adapter ring 30 shown in FIGS. 1, 2 and 3, the second fastenings 32 of the second fastening collar 34 are arranged along the circumference of the adapter ring 30 offset from the third fastenings 42 of the third fastening collar 44.

The second fastenings 32 of the second fastening collar 34 are designed here as stepped bores for completely receiving fastening screws for screwing the adapter ring 30 to the second connecting element N.

The third fastenings 42 of the third fastening collar 44 are formed here as blind holes with an internal thread.

In the variant of the large roller bearing 10 illustrated in FIGS. 1 and 2, a bearing surface 16a . . . 16d of the inner ring 12 is made of a different material (lower-grade steel) than a region 54 supporting the internal gear teeth 12a. This also applies here to the adapter ring 30, which is made of a different material (lower-grade steel) than the region 52 of the large roller bearing supporting the raceways 16a . . . 16d of the large roller bearing.

In the variant of the large roller bearing 10 illustrated in FIGS. 1 and 2, a radially projecting, circumferential nose ring 56 with an approximately rectangular cross-section is provided on the outside of the inner ring 12. This nose ring 56 has circular sector-shaped upper and lower side surfaces in cross-section, which form raceways 16b, 16c for the rolling elements 18a, 18b, which are spherical in this case, received by them. For roller-shaped rolling elements, the upper and lower side surfaces of the nose ring 56 are designed to be flat.

The rolling elements 18a, 18b can be designed as balls, rollers, barrels, or cones. In the case of rollers, the rolling elements 18a, 18b are oriented such that their longitudinal axes run radially to the longitudinal axis A of the rotor blade 2 and the large roller bearing 10. The radial extension of the nose ring 56 corresponds approximately to the diameter/length of a rolling element 18a, 18b. In the variant of the large roller bearing 10 illustrated in FIGS. 1 and 2, the nose ring 56 has a circumferential surface 58 parallel to the longitudinal axis A of the large roller bearing 10, which forms a raceway 16e for a radial bearing 60, which in the variant shown is designed as a roller bearing.

In the variant of the large roller bearing 10 illustrated in FIGS. 1 and 2, a circumferential recess 62 of approximately rectangular cross-section is provided on the inner side of the outer ring 14. This recess 62 has a radial depth which corresponds approximately to the diameter of one of the spherical rolling elements 18a, 18b. The recess 62 has circular sector-shaped upper and lower side surfaces in cross-section, which form raceways 16a, 16d for the spherical rolling elements (18a, 18b) received by them. For roller-shaped rolling elements, the upper and lower side surfaces are designed to be flat. The recess 62 is limited in the axial direction by a (upper and lower) ring collar 64, 66 projecting towards the other ring, here the inner ring 12. Between these ring collars 64, 66 and the corresponding areas of the other ring, a ring-shaped sealing element 70, 72 is arranged at the top and bottom.

In the variant of the large roller bearing 10 illustrated in FIGS. 1 and 2, the outer ring 14 is divided in the axial direction into two halves of approximately equal height. These halves are assembled and screwed together between the raceways after the rolling elements 18a, 18b, 18c have been inserted during assembly of the bearing arrangement. One half, here the lower half, also has a surface-treated raceway 68 of the radial bearing 60 corresponding to the raceway 58.

In a manner not further illustrated, the large roller bearing 10 shown in FIGS. 1-3 provides for electrical adjustment of the rotor blade angle of the rotor blade B by means of a controlled electric motor. This electric motor carries a drive pinion on its motor shaft, wherein the drive pinion meshes with internal teeth 12a arranged on the inner ring 12 in the large roller bearing 10 shown in FIGS. 1 and 2. Instead of the electric adjustment of the rotor blade B, a hydraulic adjustment by means of a controlled hydraulic cylinder, which is articulated on the inner ring 12 or on the outer ring 14, is provided in a variant not shown.

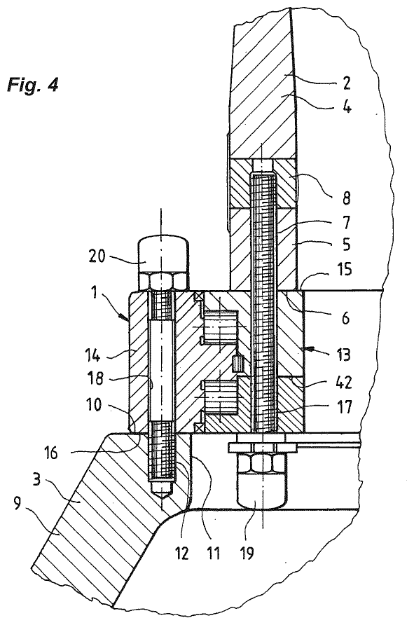

The solution presented shows that a radially extending bearing arrangement is possible, as shown in FIG. 4, for example. This allows the load-bearing raceway sections of the axial bearings to be significantly widened and larger rolling elements and/or other rolling element shapes to be used. Multi-row raceway systems can also be implemented here.

The inner and outer rings of all bearing arrangements can also be arranged in reverse compared to FIGS. 1 and 2, e.g., the T-shaped nose ring in cross-section as the outer ring and the C-shaped, split ring as the inner ring.

The rolling elements of each of the rolling bearings are held at a distance by inserted spacer elements or by cages in variants not shown here.

The rolling elements 18a, 18b of the axial bearings, whose longitudinal or rotational axes are oriented radially to the bearing axis of rotation A, are primarily used to transmit relatively high tilting or blade root bending moments caused by wind pressure on the rotor blade 2. The rolling elements 18c of the radial bearing transmit the wind pressure from the rotor blade 2 to the blade hub 3.

The variants of the device described above, their structural and operational aspects, and the variants of the method are intended solely to provide a better understanding of the structure, mode of operation, and properties; they do not limit the disclosure to the embodiments. The figures are partly schematic. Essential properties and effects are shown in part significantly enlarged in order to clarify the functions, operating principles, technical designs, and features. Any mode of operation, principle, technical design, and feature disclosed in the figures or in the text may be freely and arbitrarily combined with all claims, any feature in the text and in the other figures, other modes of operation, principles, technical designs, and features contained in this disclosure or resulting therefrom, so that all conceivable combinations of the described method can be assigned. This also includes combinations between all individual embodiments in the text, i.e., in each section of the description, in the claims, and also combinations between different variants in the text, in the claims, and in the figures. The claims also do not limit the disclosure and thus the possible combinations of all features disclosed. All disclosed features are explicitly disclosed here individually and in combination with all other features.

1. A large roller bearing comprising an inner ring and an outer ring arranged concentrically therewith, wherein
the inner ring and the outer ring are separated from each other by a bearing gap and have respective raceways for rolling elements received between these raceways;
the inner ring and the outer ring each have a first and a second end face;
the inner ring or the outer ring has a plurality of first fastening means which are arranged at a distance from one another and form a first fastening collar; wherein
each of the first fastening means is provided and designed to align with a respective fastening element of a first or second connecting element;
an adapter ring is provided and designed to extend the outer ring or the inner ring in the axial direction toward the first or second connecting element;
wherein the adapter ring
has a first and a second end face,
has a plurality of second fastening means which are arranged at intervals along the circumference of the adapter ring and form a second fastening collar, each of the second fastening means being provided and designed to be aligned with a respective fastening element of the second or first connecting element;
has a plurality of third fastening means arranged at intervals along the circumference of the adapter ring and forming a third fastening collar, each of the third fastening means being provided on the first end face of the adapter ring with a respective fastening means of the outer ring or the inner ring; and
the second fastening collar has a diameter and the third fastening collar has a diameter, wherein the diameter of the third fastening collar is greater than the diameter of the second fastening collar.

2. The large roller bearing according to claim 1, wherein the inner ring is designed as one or more parts in the axial direction and/or in the circumferential direction; and/or the outer ring is designed as one or more parts in the axial direction and/or in the circumferential direction; and/or wherein the adapter ring is connected to a second connecting element and
the running circle diameter of the large roller bearing is located closer to the mounting collar of the e fastening means of the adapter ring to the second connecting element than to the mounting collar of the fastening means of the inner or outer ring to the first connecting element, or the running circle diameter exceeds the diameter of the fastening flange of the fastening means on the adapter ring toward the second connection element; and/or wherein
the adapter ring is connected to the first connecting element and the pitch diameter is closer to the fastening flange of the fastening means of the adapter ring to the first connecting element than to the fastening flange of the inner or outer ring to the second connecting element, or the running circle diameter exceeds the diameter of the fastening flange of the fastening means on the adapter ring toward the first connecting element.

3. The large roller bearing according to claim 1, wherein
the adapter ring is designed without a raceway or with a raceway, and/or
the second fastening means of the second fastening collar are arranged along the circumference of the adapter ring offset from the third fastening means of the third fastening collar; and/or wherein
at least the second fastening means of the second fastening collar are designed as stepped bores for completely receiving fastening screws for screwing the adapter ring to the first or second connection element; and/or wherein
the third fastening means of the third fastening collar are designed as blind holes and have an internal thread.

4. The large roller bearing according to claim 1, wherein an electrical adjustment of the rotor blade is provided by means of a controlled electric motor, optionally with an intermediate gear, which carries a drive pinion on its motor shaft, wherein the drive pinion meshes with internal teeth arranged on the inner ring or an external toothing on the outer ring; or a hydraulic adjustment is provided by means of a controlled hydraulic cylinder which is articulated on the inner ring or on the outer ring.

5. The large roller bearing according to claim 4, wherein a region of the large roller bearing of the inner ring and/or of the outer ring which carries the raceways is formed from a different material than a region which carries the internal teeth or the external teeth; and/or wherein the adapter ring is made of a different material than a region of the large roller bearing supporting the raceways.

6. The large roller bearing according to claim 1, wherein a radially projecting, circumferential nose ring with an approximately rectangular cross-section is provided on the inner side of the outer ring or on the outer side of the inner ring; wherein the nose ring has circular ring-shaped upper and lower side surfaces in cross-section, which form raceways for the rolling elements received thereon.

7. The large roller bearing according to claim 1, wherein the rolling elements are designed as balls, rollers, barrels or cones; and wherein, in the case of rollers, the rolling elements are oriented such that their longitudinal axes extend radially to the longitudinal axis of the rotor blade, and/or the radial extension of the nose ring corresponds approximately to the diameter/length of a rolling element; and/or wherein the nose ring has a circumferential surface which forms a raceway for a radial bearing which is preferably designed as the manner of a roller bearing.

8. The large roller bearing according to claim 1, wherein
a circumferential recess of approximately rectangular cross-section is provided on the outside of the inner ring or on the inside of the outer ring, which recess has a depth corresponding approximately to the diameter/length of a rolling element; and/or wherein
the recess has circular ring-shaped side surfaces in cross-section, which form raceways for the rolling elements received therein; and/or wherein
the recess is bounded in the axial direction by a ring collar projecting toward the other inner or outer ring; and/or wherein between these ring bands and the corresponding regions of the other inner or outer ring there is arranged in each case a ring-shaped sealing element.

9. The large roller bearing according to claim 1, wherein
the inner ring or the outer ring is divided in the axial direction into two halves of approximately equal height, which are assembled and screwed together when the bearing arrangement is assembled after the rolling elements have been inserted; and/or wherein one of the two halves also has a raceway of the radial bearing corresponding to the raceway.

10. A wind turbine is equipped with a tower, a tower house arranged on the tower so as to be rotatable in azimuth, and a generator arranged in the tower house, which has a rotor hub on which several rotor blades are arranged so as to be rotatable about their longitudinal axis, wherein between the tower and the tower house, and/or between the tower house and the rotor hub, and/or between the rotor hub and the rotor blades at least one large roller bearing according to claim 1 is arranged between the tower and the tower house, and/or between the tower house and the rotor hub, and/or between the rotor hub and the rotor blades.

11. An adapter ring is designed and arranged to extend an outer ring or an inner ring of a large roller bearing in the axial direction toward a first connecting element, e.g., a rotor blade, or a second connecting element, e.g., a rotor hub, and wherein the adapter ring has a first and a second end face; a plurality of second fastening means; wherein such second fastening means are arranged along the circumference of the adapter ring at a distance from one another and form a second fastening collar; wherein each of the second fasteners is provided and designed to align with a corresponding fastening element of the first or second connecting element; wherein a plurality of third fasteners provided on the first end face of the adapter ring are arranged at intervals along the circumference of the adapter ring and form a third fastening collar; wherein each of the third fastening means on the first end face of the adapter ring is aligned with a corresponding fastening of the outer ring or the inner ring; wherein the diameter of the third fastening collar is greater than the diameter of the second fastening collar.

12. The adapter ring according to claim 11, wherein the adapter ring is designed without a raceway or with a raceway; and/or the second fastening means of the second fastening collar are arranged along the circumference of the adapter ring offset from the third fastening means of the third fastening collar; and/or wherein at least the second fastening means of the second fastening collar are designed as stepped bores; and/or wherein the third fastening means of the third fastening collar are formed as blind bores with internal threads.

13. A wind turbine is equipped with a tower, a tower house arranged on the tower so as to be rotatable in azimuth, and a generator arranged in the tower house, which has a rotor hub on which several rotor blades are arranged so as to be rotatable about their longitudinal axis, wherein between the tower and the tower house, and/or between the tower house and the rotor hub, and/or between the rotor hub and the rotor blades the adapter ring according to claim 11 is arranged between the tower and the tower house, and/or between the tower house and the rotor hub, and/or between the rotor hub and the rotor blades.
